(19) United States
(12) Patent Application Publication
(10) Pub. No.: US 2025/0256552 A1
(43) Pub. Date: Aug. 14, 2025

(54) System For and Method of Alerting About Cleaning of Air Purifier

(71) Applicants: HYUNDAI MOTOR COMPANY, Seoul (KR); KIA CORPORATION, Seoul (KR)

(72) Inventor: Bo-Hyeon Ryu, Hwaseong-si (KR)

(73) Assignees: HYUNDAI MOTOR COMPANY, Seoul (KR); KIA CORPORATION, Seoul (KR)

(21) Appl. No.: 18/944,641

(22) Filed: Nov. 12, 2024

(30) Foreign Application Priority Data
Feb. 8, 2024 (KR) 10-2024-0019519

(51) Int. Cl. B60H 3/06; B60H 1/00

(52) U.S. Cl. CPC B60H 3/0658; B60H 1/00742; B60H 1/008; B60H 2003/0683

(57) ABSTRACT

A method of alerting about cleaning of an air purifier includes an air purifier operating step of operating an air condition installed inside a vehicle and inputting an operational signal of the air purifier into a control unit, a sensor value inputting step of inputting information (e.g., necessary) to alert about a time for cleaning the air purifier into the control unit from sensors installed, a purification efficiency computing step of computing the purification efficiency of the air purifier, a purification efficiency comparing step of determining whether or not the purification efficiency of the air purifier is equal to or lower than reference efficiency, and a cleaning time alerting step of alerting that it is time to clean the air purifier, when the purification efficiency of the air purifier is (e.g., substantially) equal to or lower than the reference efficiency.

### CROSS-REFERENCE TO RELATED APPLICATIONS

This application claims priority to Korean Patent Application No. 10-2024-0019519, filed on Feb. 8, 2024, which is incorporated herein by reference in its entirety.

### TECHNICAL FIELD

The present disclosure relates to a method of alerting about cleaning of an air purifier installed inside a vehicle, and more particularly, to a system for and a method of alerting about cleaning of an air purifier. The system and the method being capable of alerting a cleaning time of an air purifier is provided, taking into consideration purification efficiency of the air purifier and a factor influencing on a dust concentration.

### BACKGROUND

Vehicles traveling on roads are exposed to contaminants, such as (e.g., fine) dust in the atmosphere, exhaust gas discharged from other traveling vehicles, brake particles, and tire particles.

An air purifier is installed inside the vehicle in order to protect a passenger in the vehicle from contaminants (including dust, exhaust gas, and particles) contained in the air of a passenger compartment.

Particularly, an electric precipitation-type air purifier is installed inside a vehicle, such as a bus that many people frequently get in and out of, and purifies air inside the vehicle.

For example, the electric precipitation-type air purifier is installed at a predetermined location inside the vehicle, and purifies contaminants, such as dust, that are contained in the air inside the vehicle.

When the air purifier operates normally, its purification efficiency may decrease as its operating time increases. The purification efficiency may be computed using a difference between a dust concentration in an inlet port of the air purifier and a dust concentration in an outlet port of the air purifier.

In addition, since many passengers frequently get in and out of a vehicle, such as a bus, a tram, or a subway train, a door of the vehicle is open when (e.g., each time) a passenger gets in and out of the vehicle. Thus, the fine dust or the like is introduced into the vehicle from the outside, thereby momentarily increasing a dust concentration of the air introduced into the air purifier and temporarily decreasing the purification efficiency of the air purifier.

FIG. 1 is a graph showing that efficiency decreases with a dust concentration of outside air. As shown in FIG. 1, in a state where a concentration of (e.g., fine) dust is held constant as dotted lines C1 to C4, as the operating time for the air purifier increases, the purification efficiency decreases, accordingly. Moreover, the highest concentration of (e.g., fine) dust is located on the dotted line C1, followed by those on the dotted lines C2, C3, and C4 in this order. Additionally, at the lowest concentration of (e.g., fine) dust on the dotted line C4, the purification efficiency varies according to the operating time of the air purifier. There may be a variation in reduction ratio of the purification efficiency. However, referring to FIG. 1, it may be seen that as the operating time of the air purifier increases, the purification efficiency decreases.

The door of the vehicle, such as the bus, is repeatedly opened and closed in order for a passenger to get in and get out of the vehicle. Consequently, a contamination level of air inside the vehicle tends to vary with the number of passengers as indicated by a solid line in FIG. 1. For example, when the door is open and a concentration of outside (e.g., fine) dust is (e.g., very) low, although the operating time of the air purifier increases, the purification efficiency increases temporarily (refer to portion A of the solid line). Moreover, when the door is open in a state where the concentration of the outside (e.g., fine) dust is high, the purification efficiency of the air purifier decreases temporarily (refer to portion B of the solid line). When the air purifier does not undergo a temporary change in purification efficiency, that is, when the time for which the efficiency of the air purifier is (e.g., substantially) equal to or lower than cleaning efficiency Eh preset to clean the air purifier is (e.g., substantially) equal to or longer than a predetermined time, cleaning of the air purifier is recommended (e.g., necessary). For example, in FIG. 1, in a case where the purification efficiency remains lower than the cleaning efficiency after operating time t′ (refer to portion C of the solid line), the cleaning of the air purifier is recommended (e.g., necessary).

However, in the air purifier in the related art, a driver is not alarmed that the cleaning of the air purifier is recommended (e.g., necessary). Thus, a problem arises in that a passenger is exposed to contamination due to contaminants contained in the air of the vehicle.

### SUMMARY

An object of the present disclosure, which is contrived to address the above-mentioned problem, is to provide a system for and a method of alerting about cleaning of an air purifier, the system and the method being capable of alerting about a cleaning time for the air purifier when purification efficiency of the air purifier installed inside a vehicle is lower than a preset reference efficiency.

In order to accomplish the above-mentioned object, according to one aspect of the present disclosure, there may be provided a system for alerting about cleaning of an air purifier, the system including an air purifier, and a control unit configured to compute a purification efficiency of the air purifier, determine whether or not the purification efficiency of the air purifier is (e.g., substantially) equal to or lower than a reference efficiency preset to clean the air purifier, and determine that it is time to clean the air purifier when the purification efficiency is (e.g., substantially) equal to or lower than the reference efficiency.

In the system, when (e.g., each time) the purification efficiency may be (e.g., substantially) equal to or lower than the reference efficiency, the control unit may cause an alarm counter to increment, and, when a number of alarm counts is (e.g., substantially) equal to or greater than a predetermined reference number of alarm counts, the control unit may determine that it is time to clean the air purifier.

In the system, when a purification efficiency-decreasing time, which is obtained by accumulating times for which the purification efficiency remains (e.g., substantially) equal to or lower than the reference efficiency, is (e.g., substantially) equal to or longer than a reference time, the control unit may determine that it is time to clean the air purifier.

The system may further include a display unit alerting of cleaning the air purifier, when the control unit determines that it is time to clean the air purifier.

The system may further include an introduced-dust concentration sensor measuring a dust concentration of air introduced into the air purifier, and a discharged-dust concentration sensor measuring a dust concentration of air discharged from the air purifier, wherein the control unit may compute the purification efficiency of the air purifier using a difference between a value measured by the introduced-dust concentration sensor and a value measured by the discharged-dust concentration sensor.

The system may further include a door opening sensor detecting that a door installed on the vehicle is open, and an outdoor dust concentration sensor provided on one side of the vehicle and measuring a dust concentration of outside air, wherein, when an opening signal indicating that the door is open is input into the control unit from the door opening sensor and a dust concentration of outside air, which is input into the control unit from the outdoor dust concentration sensor, is (e.g., substantially) equal to or higher than an inlet-port dust concentration in an inlet port in the air purifier, although the purification efficiency is (e.g., substantially) equal to or lower than the reference efficiency, the control unit may not determine that it is time to clean the air purifier.

The system may further include a passenger detection sensor measuring a number of passengers getting in the vehicle, wherein, when the passenger detection sensor detects that the number of passengers increases, although the purification efficiency is (e.g., substantially) equal to or lower than the reference efficiency, the control unit may not determine that it is time to clean the air purifier.

According to another aspect of the present disclosure, there is provided a method of alerting about cleaning of an air purifier, the method may include an air purifier operating step of operating an air purifier installed inside a vehicle and inputting an operational signal of the air purifier into a control unit, a sensor value inputting step of inputting information (e.g., necessary) to alert about a time for cleaning the air purifier into the control unit from sensors installed in the vehicle, an purification efficiency computing step of computing, by the control unit, purification efficiency of the air purifier, an purification efficiency comparing step of determining, by the control unit, whether or not the purification efficiency of the air purifier is (e.g., substantially) equal to or lower than reference efficiency preset to clean the air purifier, and a cleaning time alerting step of alerting, by the control unit, that it is time to clean the air purifier, when the purification efficiency of the air purifier is (e.g., substantially) equal to or lower than the reference efficiency.

The method may further include an alarm counter incrementing step of causing, by the control unit, an alarm counter to increment when (e.g., each time) the purification efficiency of the air purifier is (e.g., substantially) equal to or lower than the reference efficiency, and a number-of-counts determining step of determining, by the control unit, whether or not the number of alarm counts reaches or falls short of a predetermined reference number of alarm counts, wherein, when the number of alarm counts reaches the reference number of alarm counts, the cleaning time alerting step may be performed.

In the method, when it is not determined that the number of alarm counts is (e.g., substantially) equal to or greater than the reference number of alarm counts, returning to the purification efficiency comparing step may take place.

The method may further include a purification efficiency decrease time determining step of determining, by the control unit, whether or not a purification efficiency increasing time, which is obtained by accumulating times for which the purification efficiency remains (e.g., substantially) equal to or lower than the reference efficiency, is (e.g., substantially) equal to or longer than a reference time, wherein, when the purification efficiency increasing time is (e.g., substantially) equal to or longer than the reference time, the cleaning time alerting step may be performed.

In the method, when it is not determined, in the purification efficiency decrease time determining step, that the purification efficiency increasing time is (e.g., substantially) equal to or longer than the reference time, returning to the purification efficiency comparing step may take place.

The method may further include a door-opening determining step of determining, by the control unit, whether or not a door of the vehicle is open, and a dust concentration comparing step of determining, by the control unit, whether or not an external dust concentration outside the vehicle is (e.g., substantially) equal to or higher than an inlet-port dust concentration in an inlet port in the air purifier, wherein, when it is not determined, in the dust concentration comparing step, that the external dust concentration is (e.g., substantially) equal to or higher than the inlet-port dust concentration, the cleaning time alerting step may be performed.

The method may further include a number-of-passengers increase determining step of determining, by the controller, whether or not the number of passengers in the vehicle increases, wherein it is not determined that the number of passengers in the vehicle is greater than when the door was previously open, the cleaning time alerting step may be performed.

In the method, in the cleaning time alerting step, through a display unit installed inside the vehicle, the control unit may alert that it is time to clean the air purifier.

The system for and the method of alerting about cleaning of an air purifier, which are configured as described above, may alert about the time for cleaning the air purifier without being influenced by a factor such as outside air introduced when the door is open or the number of passengers.

Accordingly, a driver or a manager may readily recognize the cleaning time for the air purifier, such that the air purifier achieves (e.g., sufficient) purification performance.

### BRIEF DESCRIPTION OF THE DRAWINGS

FIG. 1 is a graph showing that purification efficiency decreases with a dust concentration of outside air.

FIG. 2 is a schematic view illustrating a system for alerting about cleaning of an air purifier according to an exemplary embodiment of the present disclosure.

FIG. 3 is a flowchart illustrating a method of alerting about cleaning of an air purifier according to another exemplary embodiment of the present disclosure.

FIG. 4 is a flowchart illustrating a method of alerting about cleaning of an air purifier according to a still another exemplary embodiment of the present disclosure.

### DETAILED DESCRIPTION

A system for alerting about cleaning of an air purifier and a method of cleaning an air purifier according to the present disclosure will be described in detail below with reference to the accompanying drawings.

The system for alerting about cleaning of an air purifier according to the present disclosure may include an air purifier 21 and a control unit 40. The air purifier 21 may be installed inside a vehicle 1. The control unit 40 may compute a purification efficiency of the air purifier 21 and determine whether or not the purification efficiency of the air purifier 21 is (e.g., substantially) equal to or lower than a reference efficiency Eh preset to clean the air purifier 21. When the purification efficiency is (e.g., substantially) equal to or lower than the reference efficiency Eh, the control unit 40 may determine that it is time to clean the air purifier 21.

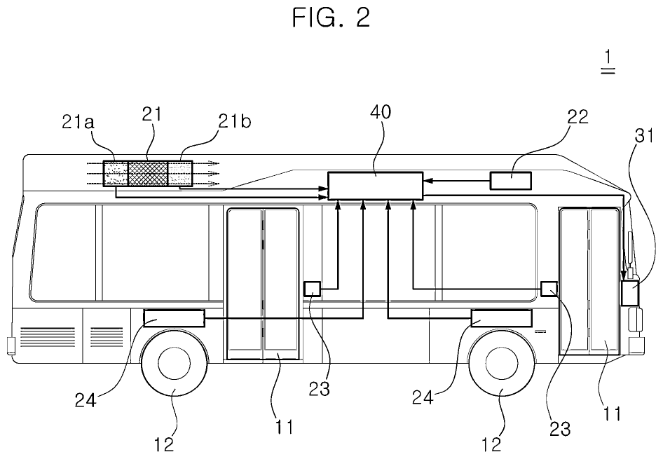

FIG. 2 illustrates an example of the system for alerting about cleaning of an air purifier according to an exemplary embodiment of the present disclosure.

The air purifier 21, which purifies air inside the vehicle 1, may be installed within the vehicle 1. The air purifier 21 may purify indoor air of the vehicle 1.

The air purifier 21 may (e.g., continuously) introduce outdoor air into the vehicle 1 and discharge indoor air out of the vehicle 1, thereby purifying air inside the vehicle 1. A filtering method that purifies air using a filter, an electric method that collects air using static electricity, a gravity method that uses gravity, and a cyclone method that uses centrifugal force, among other methods may find application in the air purifier 21 that purifies the indoor air. The air purifier 21 that purifies the indoor air may employ one of these methods or a combination thereof. Prolonged use of the air purifier 21 that employs any one of these methods may decrease the purification efficiency thereof, thereby being unable to eliminate contaminants contained in the air. Therefore, when the purification efficiency of the air purifier 21 is (e.g., substantially) equal to or lower than the reference efficiency Eh, the air purifier 21 may (e.g., should) be cleaned such that the air purifier 21 maintains a (e.g., normal) purification efficiency. At this point, the cleaning of the air purifier 21 may collectively refer to operations performed such that the air purifier 21 has to retain a (e.g., normal) purification efficiency. These operations may include replacement or cleaning of a filter, cleaning of a dust collecting plate, removal of collected dust, and the like.

An introduced-dust concentration sensor 21a and a discharged-dust concentration sensor 21b may be installed on the inlet port and the outlet port, respectively, in the air purifier 21. A concentration of dust contained in air introduced into the air purifier 21, and a concentration of dust contained in air purified and discharged in the air purifier 21 may be measured. The purification efficiency of the air purifier 21 may be computed using a difference between a dust concentration in the inlet port and a dust concentration in the outlet port in the air purifier 21. The dust concentration in the inlet port and the dust concentration in the outlet port may be measured through the introduced-dust concentration sensor 21a and the discharged-dust concentration sensor 21b, respectively.

For example, the purification efficiency of the air purifier 21 may be obtained using the Equation 1.

Purification efficiency (%)=[{(the dust concentration in the inlet port)−(the dust concentration in the outlet port)}/(dust concentration in the inlet port)]×100 Equation 1

The purification efficiency of the air purifier 21 may be a purification efficiency as of a point in time when a measurement is conducted.

At this point, a dust concentration measured by the introduced-dust concentration sensor 21a may also refer to a dust concentration of air inside the vehicle 1.

An outdoor dust concentration sensor 22 may be installed on a predetermined portion of the vehicle 1 and may measure a dust concentration of air outside the vehicle 1. Outside air may contain (e.g., fine) dust, exhaust gas discharged from the vehicle 1, particles discharged from a tire 12 or a brake, and the like. When a door 11 of the vehicle 1 is open, air may be introduced into the vehicle 1 from the outside. At this time, the discharged-dust concentration sensor 21b may measure a temporarily varied dust concentration of air discharged from the air purifier 21. In this case, the purification efficiency of the air purifier 21 may not be an actual purification efficiency of the air purifier 21. For example, when a dust concentration of outside air is high, a dust concentration of air discharged from the air purifier 21 may increase temporarily, thereby reducing the purification efficiency. Conversely, when a dust concentration of outside air is low, a dust concentration of air discharged from the air purifier 21 may decrease, thereby increasing the purification efficiency. Therefore, in order to determine a difference between a concentration of dust present inside the vehicle 1 and the dust concentration of outside air, the system for alerting about cleaning of an air purifier may further include the outdoor dust concentration sensor 22.

A door opening sensor 23 may be installed on one side of the vehicle 1 and may be configured to recognize that the door 11 of the vehicle 1 is open. When the door 11 is open in order for a passenger to get in and out of the vehicle 1, as described above, outside air may be introduced into the vehicle 1, thereby causing an influence on the dust concentration of air inside the vehicle. Consequently, the purification efficiency of the air purifier 21 that is different from the actual purification efficiency may be computed. Therefore, the door opening sensor 23 may detect that the door 11 is open and may reflect a state where the introduction of outside air is in progress.

A passenger detection sensor 24 may be installed on a predetermined portion of the vehicle 1 and may detect that a number of passengers increases or decreases. That is, when (e.g., each time) the door 11 of the vehicle 1 is open, the passenger detection sensor 24 may measure the number of passengers getting in the vehicle 1 and may measure the number of passengers getting out of the vehicle 1 such that the number of passengers in the vehicle 1 may be computed. The reason for measuring the number of passengers may be as follows. The more the number of passengers increases, the more the quality of air inside the vehicle 1 decreases. Conversely, the more the number of passengers decreases, the more the quality of air inside the vehicle 1 increases. In this manner, the number of passengers may also be a factor that has an influence on the purification efficiency of the air purifier 21.

The control unit 40 may receive an output value, as input, from the sensors described above and, when the cleaning of the air purifier 21 is recommended (e.g., required), alarm about the cleaning of the air purifier 21.

The control unit 40 may receive output values, as input, of the introduced-dust concentration sensor 21a and the discharged-dust concentration sensor 21b and compute the purification efficiency of the air purifier 21.

The control unit 40 may compare the computed purification efficiency with the reference efficiency Eh preset to clean the air purifier 21 and determine whether or not the cleaning of the air purifier 21 is recommended (e.g., necessary). That is, when the purification efficiency is (e.g., substantially) equal to or lower than the reference efficiency Eh, the control unit 40 may determine that it is time to clean the air purifier 21.

In addition, the control unit 40 may receive output values, as input, of the door opening sensor 23, the outdoor dust concentration sensor 22, and the passenger detection sensor 24 and determine whether or not the earlier computed purification efficiency is caused by an external factor.

The method of cleaning an air purifier, which is described below, may be stored, as a set of instructions, in the control unit 40. Thus, the method of cleaning an air purifier may be configured to be realized by the system for alerting about cleaning of an air purifier according to the present disclosure.

The control unit 40 may compare the purification efficiency of the air purifier 21, which is computed by the control unit 40, with the reference efficiency. When the purification efficiency of the air purifier 21 is (e.g., continuously) maintained to be (e.g., substantially) equal to or lower than the reference efficiency Eh, the control unit 40 may alert that it is time to clean the air purifier 21. At this point, an alarm counter or an accumulated amount of time may be used to determine whether or not the purification efficiency remains (e.g., substantially) equal to or lower than the reference efficiency Eh. For example, the alarm counter may (e.g., be caused to) increment when (e.g., each time) a predetermined time for which the purification efficiency remains (e.g., substantially) equal to or lower than the reference efficiency Eh elapses. When the accumulated number of alarm counts reaches or exceeds a reference number of alarm counts, it may be determined that it is time to clean the air purifier 21. Alternatively, when an efficiency decreasing time, for which the purification efficiency remains (e.g., substantially) equal to or lower than the reference efficiency Eh, reaches or exceeds a reference time, it may be determined that it is time to clean the air purifier 21.

A process in which the control unit 40 computes the purification efficiency of the air purifier 21 and alerts about a cleaning time is described in detail below, along with the method of cleaning an air cleaning.

A display unit 31 may be installed on a predetermined portion of the inside of the vehicle 1 and may notify a driver that it is time to clean the air purifier 21. The display unit 31 may be a cluster, a warning light, a speaker, or the like. For example, letters, a graphic, and the like may be displayed on the cluster, indicating that it is time to clean the air purifier 21. Alternatively, the warning light installed on one side of the vehicle 1 may be turned on or the speaker installed on one side of the vehicle 1 may output an audio signal, alarming the driver that it is time to clean the air purifier 21. The display unit 31 may not be installed on the vehicle 1. Instead, the display unit 31 may be a terminal that establishes a connection to the control unit 40 through wireless communication in order to manage the vehicle 1.

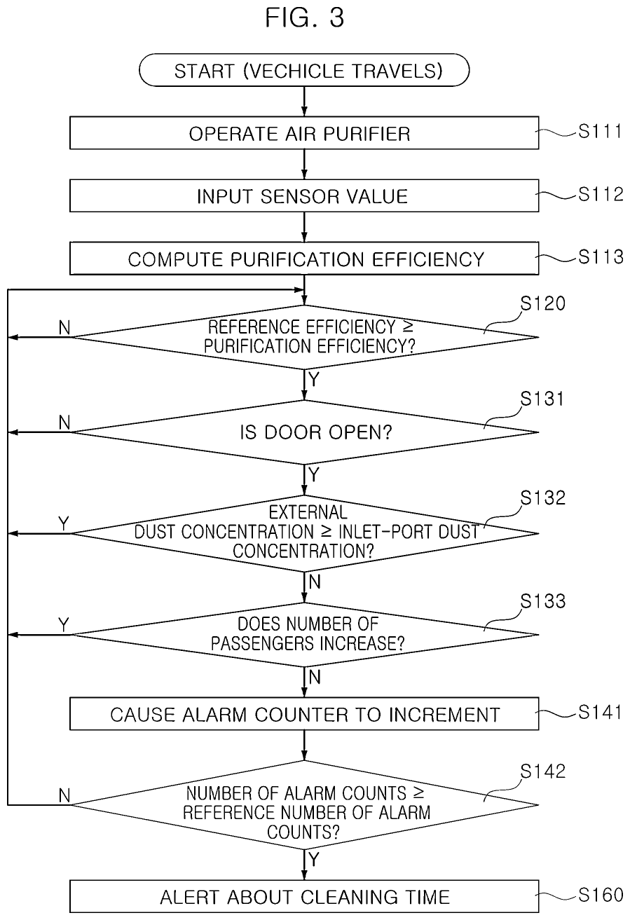

FIG. 3 illustrates a method of alerting about cleaning of an air purifier according to another exemplary embodiment of the present disclosure.

The method of alerting about cleaning of an air purifier according to another exemplary embodiment of the present disclosure may include an air purifier operating step S111, a sensor value inputting step S112, a purification efficiency computing step S113, a purification efficiency comparing step S120, and a cleaning time alerting step S160. In the air purifier operating step S111, the air purifier 21 installed inside the vehicle 1 may operate, and an operational signal of the air purifier 21 may be input into the control unit 40. In the sensor value inputting step S112, information (e.g., necessary) to alert about a time for cleaning the air purifier 21 may be input into the control unit 40 from sensors installed in the vehicle 1. In the efficiency computing step S113, the control unit 40 may compute the purification efficiency of the air purifier 21. In the efficiency comparing step S120, the control unit 40 may determine whether or not the purification efficiency of the air purifier 21 is (e.g., substantially) equal to or lower than the reference efficiency Eh preset to clean the air purifier 21. In the cleaning time alerting step S160, when the purification efficiency of the air purifier 21 is (e.g., substantially) equal to or lower than the reference efficiency Eh, the control unit 40 may alarm that it is time to clean the air purifier 21.

In the air purifier operating step S111, the air purifier 21 installed inside the vehicle 1 may operate, and the operating signal of the air purifier 21 may be input into the control unit 40. The air purifier 21 may be operated manually by the driver. Alternatively, when a dust concentration inside the vehicle 1 satisfies a preset condition, the control unit 40 may operate the air purifier 21. When the air purifier 21 operates manually or automatically, the operational signal of the air purifier 21 may be input into the control unit 40 such that the control unit 40 recognizes that the air purifier 21 is in operation.

In the sensor value inputting step S112, the information (e.g., necessary) to alert about the time for cleaning the air purifier 21 may be input into the control unit 40 from the sensors installed in the vehicle 1. The introduced-dust concentration sensor 21a that measures a dust concentration of air introduced into the air purifier 21 and the discharged-dust concentration sensor 21b that measures a dust concentration of the air discharged from the air purifier 21 may be installed in the vehicle 1. In addition, the outdoor dust concentration sensor 22 for measuring a dust concentration of outside air, the door opening sensor 23 for detecting whether or not the door 11 of the vehicle 1 is open, and the passenger detection sensor 24 for computing the number of passengers getting in the vehicle 1 may be installed in the vehicle 1. The control unit 40 may receive output signals, as input, from the introduced-dust concentration sensor 21a, the discharged-dust concentration sensor 21b, the outdoor dust concentration sensor 22, the door opening sensor 23, and the passenger detection sensor 24.

In the efficiency computing step S113, the control unit 40 may compute the purification efficiency of the air purifier 21. The control unit 40 may compute the purification efficiency of the air purifier 21 using a difference between the dust concentration measured by the introduced-dust concentration sensor 21a and the dust concentration measured by the discharged-dust concentration sensor 21b.

For example, the purification efficiency of the air purifier 21 may be obtained using Equation 1.

The purification efficiency of the air purifier 21 may be a purification efficiency as of a point in time when a measurement is conducted.

At this point, the dust concentration measured by the introduced-dust concentration sensor 21a may also refers to a dust concentration of air inside the vehicle 1.

In the efficiency comparing step S120, the control unit 40 may determine whether or not the purification efficiency of the air purifier 21 is (e.g., substantially) equal to or lower than the reference efficiency Eh preset to clean the air purifier 21.

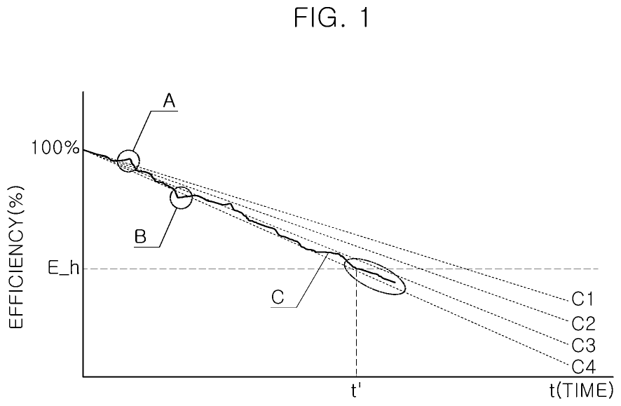

When determining in the efficiency comparing step S120, whether or not the purification efficiency is (e.g., substantially) equal to or lower than the reference efficiency Eh, the control unit 40 may use a technique in which, from the graph in FIG. 1, it is determined that the purification efficiency of the air purifier 21 becomes (e.g., substantially) equal to or lower than the reference efficiency Eh. A portion, denoted by C, of the graph in FIG. 1 shows that, after operating time t for the air purifier 21 reaches time t′, the purification efficiency becomes (e.g., substantially) equal to or smaller than the reference efficiency Eh.

In a door-opening determining step S131, the control unit 40 may determine whether or not the door 11 of the vehicle 1 is open. That is, using the door opening sensor 23, the control unit 40 may detect whether or not the door 11 is open. When it is determined in the door-opening determining step S131 that the door 11 is open, the next step S132 may be performed. When it is not determined in the door-opening determining step S131 that the door 11 is open, returning to the efficiency comparing step S120 may take place.

In a dust concentration comparing step S132, the control unit 40 may compare whether or not an external dust concentration of outside air is (e.g., substantially) equal to or higher than an inlet-port dust concentration in the inlet port in the air purifier 21.

In the dust concentration comparing step S132, when it is not determined that the external dust concentration is (e.g., substantially) equal to or lower than the inlet-port dust concentration, the next step S133 may be performed.

If the external dust concentration measured by the outdoor dust concentration sensor 22 is (e.g., substantially) equal to or higher than the inlet-port dust concentration measured by the introduced-dust concentration sensor 21a, this means that air with a high dust concentration is introduced from the outside, thereby temporarily decreasing the efficiency of the air purifier 21. Therefore, returning to the efficiency comparing step S120 may take place because the dust concentration comparing step S132 and subsequent steps may not (e.g., do not need to) be performed.

When it is determined in the door-opening determining step S131 that the door 11 is open, it may be (e.g., is preferred) that the dust concentration comparing step S132 is performed.

In the number-of-passengers increase determining step S133, the control unit 40 may determine whether or not the number of passengers in the vehicle 1 increases. Using the passenger detection sensor 24, the control unit 40 may compute the number of passengers and determine whether or not the number of passengers increases or decreases.

If the number of passengers is greater than when the door 11 was previously open, this means that an increase in the number of passengers causes air inside the vehicle 1 to be contaminated, thereby decreasing the efficiency. Therefore, returning to the efficiency comparing step S120 may take place.

However, the next step may be performed when it is determined that the number of passengers is greater than when the door 11 was previously open, that is, when the number of passengers is (e.g., substantially) the same as or smaller than at the time.

The control unit 40 may determine that the purification efficiency of the air purifier 21 decreases, according to the results in the door-opening determining step S131, the dust concentration comparing step S132, and the number-of-passengers increase determining step S133. Then, the control unit 40 may alert the driver or a passenger of the decrease in the purification efficiency. However, the purification efficiency of the air purifier 21 may decrease temporarily. Therefore, when the purification efficiency of the air purifier 21 remains lower than the reference efficiency Eh, the control unit 40 may determine that the cleaning of the air purifier 21 is recommended (e.g., necessary).

For example, according to another exemplary embodiment of the present disclosure, using a counter, it is determined whether or not the cleaning of the air purifier 21 is recommended (e.g., necessary). To this end, an alarm counter incrementing step S141 and a number-of-counts determining step S142 may be performed.

In the alarm counter incrementing step S141, the control unit 40 may cause the alarm counter to increment when (e.g., each time) the purification efficiency reaches or falls short of the reference efficiency Eh. The control unit 40 may cause the alarm counter to increment when (e.g., each time) the purification efficiency reaches or falls short of the reference efficiency Eh and accumulates alarm counts.

In the number-of-counts determining step S142, the control unit 40 may determine whether or not the number of alarm counts is (e.g., substantially) equal to or greater than the predetermined reference number of alarm counts. When the number of accumulated alarm counts reaches the reference number of alarm counts, this means that the purification efficiency remains in the same state, not that the purification efficiency decreases temporarily. Therefore, when the number of accumulated alarm counts is (e.g., substantially) equal to or greater than the reference number of alarm counts, the control unit 40 may confirm that the cleaning of the air purifier 21 is recommended (e.g., necessary).

When it is confirmed in this manner that the cleaning of the air purifier 21 is recommended (e.g., necessary), the control unit 40 may perform the cleaning time alerting step S160 in which the control unit 40 alarms that it is time to clean the air purifier 21.

In the cleaning time alerting step S160, the control unit 40 may alert the driver or the passenger that it is time to clean the air purifier 21 using the display unit 31, for example, the cluster, the warning light, the speaker, or the like, that is installed in the vehicle 1.

In this manner, it is alerted that the purification efficiency of the air purifier 21 decreases, without an influence of external factors, such as outside air and the number of passengers, on the purification efficiency of the air purifier 21. Consequently, the air purifier 21 may be cleaned, and the air purifier 21 may efficiently purify air.

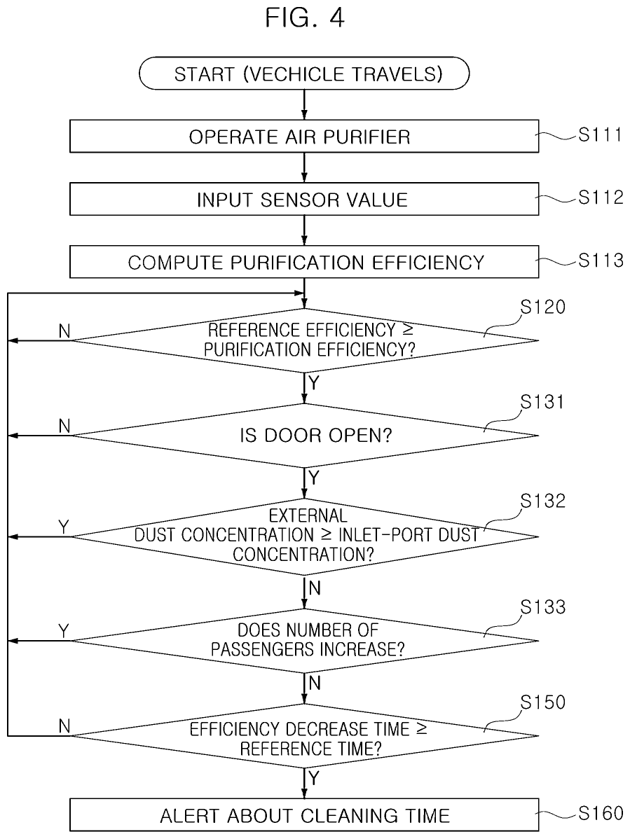

FIG. 4 illustrates a method of alerting about cleaning of an air purifier according to still another exemplary embodiment of the present disclosure.

The method of alerting about cleaning of an air purifier according to still another exemplary embodiment of the present disclosure shown in FIG. 4 may have a similar configuration to that according to another exemplary embodiment of the present disclosure shown in FIG. 3. However, according to the exemplary embodiment of the present disclosure shown in FIG. 4, in order to determine the cleaning time, the purification efficiency decreasing time for which the purification efficiency remains (e.g., substantially) equal to or lower than the reference efficiency Eh is compared with the reference time without the use of the alarm counter. That is, a purification efficiency decrease time determining step S150 is performed instead of the alarm counter incrementing step S141 and the number-of-counts determining step S142, and it is determined whether or not it is time to clean the air purifier 21.

The air purifier operating step S111, the number-of-passengers increases determining step S133, and the cleaning time alerting step S160 may be the same as those according to another exemplary embodiment shown in FIG. 3.

In the purification efficiency decrease time determining step S150, the control unit 40 may compare the efficiency decreasing time, which is obtained by accumulating times for which the purification efficiency remain (e.g., substantially) equal to or lower than the reference efficiency Eh, with the reference time. When the purification efficiency decreasing time is (e.g., substantially) equal to or longer than the reference time, the control unit 40 may determine that it is time to clean the air purifier 21.

What is claimed is:

1. A system for alerting about cleaning of an air purifier, the system comprising: an air purifier; and
a control unit configured to:
compute a purification efficiency of the air purifier,
determine whether or not the purification efficiency of the air purifier is equal to or lower than a reference efficiency preset to clean the air purifier, and
determine that it is time to clean the air purifier when the purification efficiency is equal to or lower than the reference efficiency.

2. The system of claim 1, wherein each time the purification efficiency is equal to or lower than the reference efficiency, the control unit causes an alarm counter to increment, and
wherein, when a number of alarm counts is equal to or greater than a predetermined reference number of alarm counts, the control unit determines that it is time to clean the air purifier.

3. The system of claim 1, wherein, when a purification efficiency decreasing time, which is obtained by accumulating times for which the purification efficiency remains equal to or lower than the reference efficiency, is equal to or longer than a reference time, the control unit determines that it is time to clean the air purifier.

4. The system of claim 1, further comprising
a display unit alerting that it is time to clean the air purifier, when the control unit determines that it is time to clean the air purifier.

5. The system of claim 1, further comprising:
an introduced-dust concentration sensor measuring a dust concentration of air introduced into the air purifier; and
a discharged-dust concentration sensor measuring a dust concentration of air discharged from the air purifier,
wherein the control unit computes the purification efficiency of the air purifier using a difference between a value measured by the introduced-dust concentration sensor and a value measured by the discharged-dust concentration sensor.

6. The system of claim 1, further comprising:
a door opening sensor detecting that a door installed on a vehicle is open; and
an outdoor dust concentration sensor provided on one side of the vehicle and measuring a dust concentration of outside air,
wherein, when an opening signal indicating that the door is open is input into the control unit from the door opening sensor and a dust concentration of outside air, which is input into the control unit from the outdoor dust concentration sensor, is equal to or higher than an inlet-port dust concentration in an inlet port in the air purifier, although the purification efficiency is equal to or lower than the reference efficiency, the control unit does not determine that it is time to clean the air purifier.

7. The system of claim 6, further comprising:
a passenger detection sensor measuring a number of passengers getting in the vehicle,
wherein, when the passenger detection sensor detects that the number of passengers increases, although the purification efficiency is equal to or lower than the reference efficiency, the control unit does not determine that it is time to clean the air purifier.

8. A method of alerting about cleaning of an air purifier, the method comprising:
an air purifier operating step of operating an air purifier installed inside a vehicle and inputting an operational signal of the air purifier into a control unit;
a sensor value inputting step of inputting information to alert about a time for cleaning the air purifier into the control unit from sensors installed in the vehicle;
a purification efficiency computing step of computing, by the control unit, a purification efficiency of the air purifier;
a purification efficiency comparing step of determining, by the control unit, whether the purification efficiency of the air purifier is equal to or lower than reference efficiency preset to clean the air purifier; and
a cleaning time alerting step of alerting, by the control unit, that it is time to clean the air purifier, when the purification efficiency of the air purifier is equal to or lower than the reference efficiency.

9. The method of claim 8, further comprising:
an alarm counter incrementing step of causing, by the control unit, an alarm counter to increment each time the purification efficiency of the air purifier is equal to or lower than the reference efficiency; and
a number-of-counts determining step of determining, by the control unit, whether or not the number of alarm counts reaches or falls short of a predetermined reference number of alarm counts,
wherein, when the number of alarm counts reaches the predetermined reference number of alarm counts, the cleaning time alerting step is performed.

10. The method of claim 9, wherein, when it is determined that the number of alarm counts is not equal to or greater than the predetermined reference number of alarm counts, returning to the efficiency comparing step takes place.

11. The method of claim 8, further comprising:
a purification efficiency decrease time determining step of determining, by the control unit, whether a purification efficiency increasing time, which is obtained by accumulating times for which the purification efficiency remains equal to or lower than the reference efficiency, is equal to or longer than a reference time,
wherein, when the purification efficiency increasing time is equal to or longer than the reference time, the cleaning time alerting step is performed.

12. The method of claim 11, wherein, when it is determined, in the purification efficiency decrease time determining step, that the purification efficiency increasing time is not equal to or longer than the reference time, returning to the purification efficiency comparing step takes place.

13. The method of claim 8, further comprising:
a door-opening determining step of determining, by the control unit, whether or not a door of the vehicle is open; and
a dust concentration comparing step of determining, by the control unit, whether or not an external dust concentration outside the vehicle is equal to or higher than an inlet-port dust concentration in an inlet port in the air purifier,
wherein, when it is not determined, in the dust concentration comparing step, that the external dust concentration is equal to or higher than the inlet-port dust concentration, the cleaning time alerting step is performed.

14. The method of claim 13, further comprising:
a number-of-passengers increase determining step of determining, by the control unit, whether the number of passengers in the vehicle increases,
wherein it is determined that the number of passengers in the vehicle is not greater than when the door was previously open, the cleaning time alerting step is performed.

15. The method of claim 8, wherein, in the cleaning time alerting step, through a display unit installed inside the vehicle, the control unit alerts that it is time to clean the air purifier.
